(19) United States
(12) Patent Application Publication
(10) Pub. No.: US 2001/0010585 A1
(43) Pub. Date: Aug. 2, 2001

(54) Raman amplifier and optical transmission system

(75) Inventors: Masayuki Nishimura, Yokohama-shi (JP); Eisuke Sasaoka, Yokohama-shi (JP); Toshiaki Okuno, Yokohama-shi (JP)

Correspondence Address: MCDERMOTT WILL & EMERY, 600 13TH STREET, N.W., WASHINGTON, DC, 20005-3096, US

(73) Assignee: Sumitomo Electric Industries, Ltd.

(21) Appl. No.: 09/768,354

(22) Filed: Jan. 25, 2001

(30) Foreign Application Priority Data
Jan. 27, 2000 (JP) P2000-019043

(51) Int. Cl. H01S 3/00; H04J 14/02

(52) U.S. Cl. 359/124; 359/334

(57) ABSTRACT

The present invention is related to a Raman amplifier for Raman-amplifying optical signals by supplying pumping light to an optical fiber through which the optical signals propagate, and an optical transmission system having this Raman amplifier in a repeater section. In a Raman amplifier, pumping light output from a light source for optical pumping is supplied to a Raman amplification optical fiber through an optical multiplexer. Optical signals input from an upstream end portion to the Raman amplification optical fiber suffer transmission loss while propagating through the Raman amplification optical fiber, and are also Raman-amplified by the Raman amplification optical fiber. The Raman amplification optical fiber has a polarization coupling means for inducing coupling between the polarization components of propagation light, e.g., a twist applied to the glass portion of the Raman amplification optical fiber. Thus, the polarization states of the optical signals and pumping light are randomized in the longitudinal direction of the Raman amplification optical fiber, and the Raman amplification gain of the Raman amplifier is averaged and stabilized over time.

### BACKGROUND OF THE INVENTION

1. Field of the Invention

The present invention relates to a Raman amplifier for Raman-amplifying optical signals by supplying pumping light to an optical fiber through which the optical signals propagate, and an optical transmission system having this Raman amplifier in a repeater section.

2. Related Background Art

An optical fiber amplifier comprises an optical amplification optical fiber and pumping light supply means, and optically amplifies optical signals to compensate for loss when the optical signals propagate through an optical transmission line in an optical transmission system. More specifically, when pumping light having a predetermined wavelength is supplied to the optical amplification optical fiber by the pumping light supply means, and optical signals are input to the optical amplification optical fiber, the input optical signals are optically amplified by the optical amplification optical fiber to be output.

Examples of such an optical fiber amplifier are a rare-earth-element-doped optical fiber amplifier which uses an optical fiber having a rare earth element (e.g., Er) doped in an optical waveguide region and a Raman amplifier using a Raman amplification phenomenon. A rare-earth-element-doped optical fiber amplifier is provided in a repeater or the like as a module. For a Raman amplifier, an optical amplification optical fiber (Raman amplification optical fiber) is used as an optical transmission line or part thereof, through which optical signals propagate, and the optical signals are amplified in this Raman amplification optical fiber. Hence, when the Raman amplifier is used, the effective loss in the optical transmission line can be reduced, and a nonlinear optical phenomenon that is caused when the optical signals have too large power at various portions of the optical transmission line can be suppressed.

In such a Raman amplifier, the relationship between the plane of polarization of the optical signals and that of pumping light, which propagate through the Raman amplification optical fiber, is known to affect the Raman amplification gain. More specifically, the Raman amplification gain is maximized when the plane of polarization of the optical signals and that of pumping light, which propagate through the Raman amplification optical fiber, match. When the two planes of polarization are perpendicular to each other, the Raman amplification gain degrades to about 1/10 the maximum value. Also, when the plane of polarization of light propagating through the Raman amplification optical fiber varies in the longitudinal direction, the Raman amplification gain is known to decrease to about ½ the maximum value (for example, reference 1, S. E. Miller, et al., “optical fiber telecommunications”, Academic press, Inc., p. 131 (1979)).

Generally, a semiconductor laser source is used as a light source for optical pumping or a light source for optical signals. Light (pumping light or optical signals) output from the semiconductor laser source is linearly polarized. Additionally, in a single-mode optical fiber generally used as an optical transmission line or Raman amplification optical fiber, the plane of polarization of propagating light changes only in a very small amount, and the plane of polarization is almost maintained. Especially, since the recent progress in cable technology prevents disturbance or side pressure to an optical fiber, the plane of polarization of light propagating through the optical fiber is maintained with least change.

When optical signals or pumping light output from a semiconductor laser source is launched into an optical fiber which maintains the plane of polarization of propagation light with least change, the relationship between the plane of polarization of the optical signals and that of the pumping light is fixed to a certain degree. On the other hand, the fixed state may vary over time. In this case, the Raman amplification gain varies over time depending on the change in relationship between the plane of polarization of the optical signals and that of the pumping light.

In a known technique devised to solve this problem, laser beams output from two semiconductor laser sources are multiplexed by a polarization multiplexer while making the planes of polarization perpendicular to each other, and the multiplexed light is used as pumping light (reference 2, H. Masuda, et al., “Ultrawide 75-nm 3-dB Gain-Band Optical Amplification with Erbium-Doped Fluoride Fiber Amplifiers and Distributed Raman Amplifiers”, IEEE Photon, Tech. Lett., Vol. 10, No. 4, pp. 516-518 (1998)). This technique suppresses a variation in Raman amplification gain over time by sending such pumping light into a Raman amplification optical fiber.

### SUMMARY OF THE INVENTION

The present inventors examined the above prior art and found the following problems. In the technique described in reference 2, since two semiconductor laser sources and a polarization multiplexer must be used, the number of optical components is large, and the system becomes expensive. In addition, when the output power ratio between the two semiconductor laser sources varies, the Raman amplification gain varies accordingly.

The present invention has been made to solve the above problems, and has as its object to provide a Raman amplifier which can obtain a stable Raman amplification gain by a simple and inexpensive arrangement, and an optical transmission system having this Raman amplifier in a repeater section.

According to the present invention, there is provided a Raman amplifier comprising a Raman amplification optical fiber through which optical signals pass and which Raman-amplifies the optical signals upon receiving pumping light, the Raman amplification optical fiber having polarization coupling means for inducing coupling between polarization components of propagation light, and pumping light supply means for supplying the pumping light to the Raman amplification optical fiber.

In this Raman amplifier, pumping light is supplied from the pumping light supply means to the Raman amplification optical fiber. The optical signals input to the Raman amplification optical fiber suffers transmission loss while propagating through the Raman amplification optical fiber and are also Raman-amplified by the Raman amplification optical fiber to be output. In the Raman amplification optical fiber, by the polarization coupling means for inducing coupling between polarization components of propagation light, the polarization states of the optical signals and pumping light are randomized in the longitudinal direction of the Raman amplification optical fiber. Hence, the Raman amplification gain of the Raman amplifier is averaged and stabilized over time. In addition, the number of optical components is small, and the system is inexpensive, unlike the technique disclosed in reference 2 described in “Related Background Art”.

In the Raman amplifier according to the present invention, the polarization coupling means of the Raman amplification optical fiber preferably comprises a twist applied to a glass portion of the Raman amplification optical fiber. With this arrangement, coupling is induced between the polarization components of propagation light by this twist, so the polarization states of the optical signals and pumping light are randomized in the longitudinal direction of the Raman amplification optical fiber. At this time, an average value of pitches of the twist is preferably not less than 2 times/m. This induces sufficient coupling between the polarization components of propagation light.

According to the present invention, there is also provided an optical transmission system having the above Raman amplifier in a repeater section, wherein the Raman amplification optical fiber of the Raman amplifier constitutes at least a part of an optical transmission line of the repeater section.

According to this optical transmission system, optical signals that propagate through the optical transmission line in the repeater section suffers transmission loss while propagating through the Raman amplification optical fiber and are also Raman-amplified by the Raman amplification optical fiber to be output. Hence, the effective loss in the optical transmission line can be reduced, and a nonlinear optical phenomenon that is caused when the optical signals have too large power at various portions of the optical transmission line can be suppressed. In the Raman amplification optical fiber, by the polarization coupling means for inducing coupling between polarization components of propagation light, the polarization states of the optical signals and pumping light are randomized in the longitudinal direction of the Raman amplification optical fiber. Hence, the Raman amplification gain (i.e., the power of the optical signals arriving at the receiving end) is averaged and stabilized over time. In addition, the number of optical components is small, and the system is inexpensive, unlike the technique disclosed in reference 2 described in “Related Background Art”.

The present invention will become more fully understood from the detailed description given hereinbelow and the accompanying drawings. They are given by way of illustration only, and thus should not be considered limitative of the present invention.

### BRIEF DESCRIPTION OF THE DRAWINGS

FIG. 1 is a view schematically showing a preferred embodiment of a Raman amplifier according to the present invention;

FIG. 2 is a view for explaining a Raman amplification optical fiber provided in the Raman amplifier of the embodiment;

FIGS. 3A to 3H are sectional views of the Raman amplification optical fiber viewed along line A-A to H-H shown in FIG. 2;

FIG. 4A is a view for explaining the process of manufacturing the Raman amplification optical fiber of the Raman amplifier according to the embodiment;

FIG. 4B is a view showing the structure of an optical fiber preform;

FIGS. 4C and 4D are views showing the structures of a drawn optical fiber at positions C and D shown in FIG. 4A;

FIG. 5 is a plan view of a swing guide roller and first fixed guide roller shown in FIG. 4A;

FIG. 6 shows a side view of a pair of guide rollers for suppressing optical fiber movement and a plan view of the swing guide roller shown in FIG. 4A, in which the side view is on the upper side of a line X-X, and the plan view is on the lower side of the line X-X; and

FIG. 7 is a view schematically showing a preferred embodiment of an optical transmission system according to the present invention.

### DESCRIPTION OF THE PREFERRED EMBODIMENTS

The embodiments of the present invention will be described below in detail with reference to the accompanying drawings. The same reference numerals denote the same elements throughout the drawings, and a detailed description thereof will be omitted.

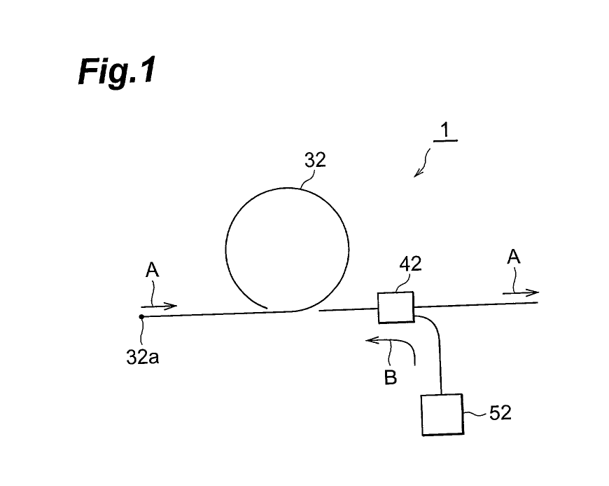

A preferred embodiment of a Raman amplifier according to the present invention will be described. FIG. 1 is a view schematically showing a Raman amplifier 1 according to this embodiment. This Raman amplifier 1 has a Raman amplification optical fiber 32, optical multiplexer 42, and light source 52 for optical pumping.

The Raman amplification optical fiber 32 having a length of, e.g., several to several ten km serves as an optical transmission line through which optical signals pass and also serves as an optical amplification medium for Raman-amplifying optical signals upon receiving pumping light. This Raman amplification optical fiber 32 is a single-mode fiber in the signal wavelength band and uses silica glass as a base. To suppress waveform degradation in optical signals due to accumulated wavelength dispersion, this Raman amplification optical fiber 32 is preferably formed from a dispersion-shifted optical fiber having a zero dispersion wavelength near but not exactly the same as the optical signal wavelength (1.55 μm).

The light source 52 for optical pumping outputs pumping light and preferably comprises, e.g., a semiconductor laser source. The optical multiplexer 42 inputs pumping light output from the light source 52 for optical pumping to the Raman amplification optical fiber 32 and passes optical signals Raman-amplified by the Raman amplification optical fiber 32 downstream (right side of FIG. 1). Note that when the wavelength of optical signals is about 1.55 μm, the wavelength of pumping light for Raman amplification is about 1.45 μm, i.e., shorter than the wavelength of the optical signals by about 0.1 μm.

In this Raman amplifier 1, pumping light output from the light source 52 for optical pumping is supplied to the Raman amplification optical fiber 32 through the optical multiplexer 42 in a direction (direction B in FIG. 1) opposite to the optical signals propagation direction (direction A in FIG. 1). Optical signals input from an end portion 32a upstream (left side of FIG. 1) to the Raman amplification optical fiber 32 suffers transmission loss when propagating through the Raman amplification optical fiber 32, and is also Raman-amplified by the Raman amplification optical fiber 32. The optical signals Raman-amplified by the Raman amplification optical fiber 32 is output downstream (right side of FIG. 1) through the optical multiplexer 42.

The Raman amplification optical fiber 32 has a polarization coupling means for inducing coupling between the polarization components of propagation light. This polarization coupling means is formed from, e.g., a twist applied to the glass portion of the Raman amplification optical fiber 32. To randomize the polarization state by coupling between polarization components of propagation light, the average value of pitches of the twist is preferably 2 times/m or more, and more preferably, 2 to 10 times/m. By this polarization coupling means, the polarization states of the optical signals and pumping light are randomized in the longitudinal direction of the Raman amplification optical fiber 32, and the Raman amplification gain of the Raman amplifier 1 is averaged and stabilized over time. In addition, unlike the technique of reference 2 described in “Related Background Art”, two semiconductor laser sources and a polarization coupler need not be prepared. Since one semiconductor laser source suffices as a light source 52 for optical pumping, the number of optical components is small, and the system is inexpensive.

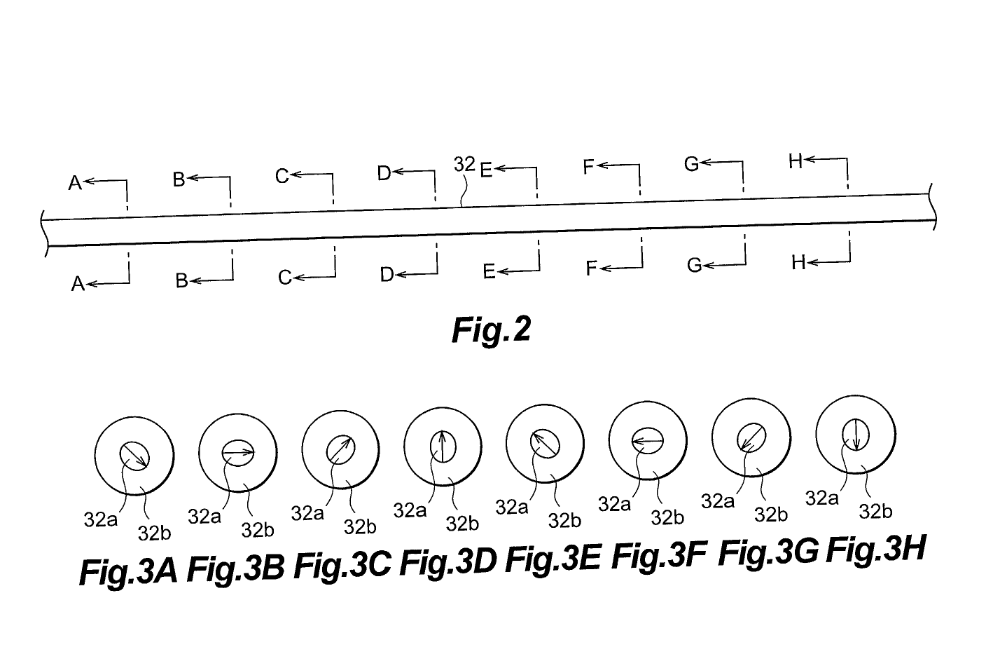

FIG. 2 is a view for explaining the Raman amplification optical fiber 32 provided in the Raman amplifier 1 of this embodiment. FIGS. 3A to 3H are sectional views of the Raman amplification optical fiber 32 viewed along line A-A to H-H shown in FIG. 2.

As shown in FIGS. 3A to 3H, in the cross-section of the Raman amplification optical fiber 32, a core region 32a at the center is surrounded by a cladding region 32b. The core region 32a has not a completely circular but a slightly elliptical cross-section. The arrows in the core region 32a shown in FIGS. 3A to 3H indicate the major-axis direction of the ellipses. The Raman amplification optical fiber 32 has different major-axis directions in the longitudinal direction. The major-axis direction rotates in the longitudinal direction. This rotation of major-axis direction corresponds to the twist (polarization coupling means) applied to the glass portion of the Raman amplification optical fiber 32.

A detailed example of the Raman amplification optical fiber of the Raman amplifier according to this embodiment will be described next. As the Raman amplification optical fiber 32, a 10-km long dispersion-shifted optical fiber having an average twist pitch value of 2.5 times/m and a zero dispersion wavelength near but not exactly the same as 1.55 μm was used here. As the light source for optical signals, a semiconductor laser source for outputting a linearly polarized laser beam having a wavelength of 1.55 μm was used. As the light source 52 for optical pumping, a semiconductor laser source for outputting a linearly polarized laser beam having a wavelength of 1.45 μm was used. The power of optical signals incident on the Raman amplifier 1 was −20 dBm, and the output power of the pumping light was 180 mW.

The power of optical signals emerging from the Raman amplifier 1 was measured while rotating the plane of polarization of the optical signals incident on the Raman amplifier 1 by a polarization controller. As a result of measurement, the variation width of the output power of the optical signals was 0.1 dB or less. When measurement was done in the same way as described above using a normal dispersion-shifted optical fiber without twist, the variation width of the output power of the optical signals was about 0.4 dB. As described above, the Raman amplification gain of the Raman amplifier 1 according to this embodiment was stable.

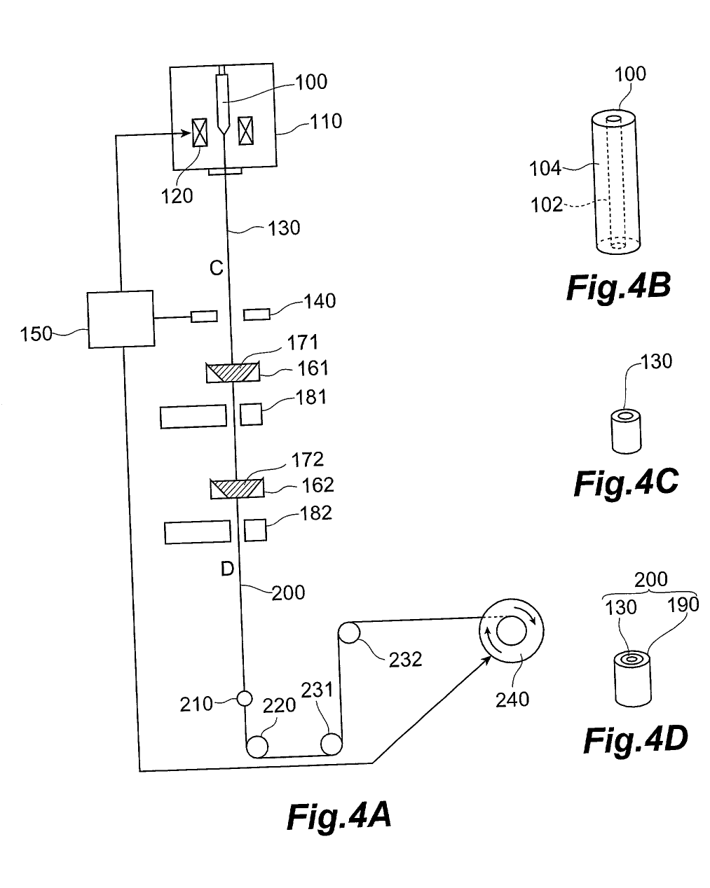

A method of manufacturing the Raman amplification optical fiber 32 will be described next. FIG. 4A is a view for explaining the process of manufacturing the Raman amplification optical fiber 32. As shown in FIG. 4A, first an optical fiber preform 100 is prepared and set in a drawing furnace 110. The optical fiber preform 100 is made by vapor phase axial deposition (VAD), outside vapor phase deposition (OVD), modified chemical vapor deposition (MCVD), or rod-in-tube method. The optical fiber preform 100 has a core portion 102 and cladding portion 104, as shown in FIG. 4B, and contains silica glass as a main component. The dopant concentration is uniform in the longitudinal direction, and the refraction index profile is also uniform in the longitudinal direction.

After the optical fiber preform 100 is set in the drawing furnace 110, the lower end of the optical fiber preform 100 is heated and softened by a heater 120 in the drawing furnace 110 to draw an optical fiber 130. The drawing speed at this time is, e.g., 100 m/min. In drawing, the outer diameter of the drawn optical fiber 130 is measured by a laser outer-diameter measurement device 140. The measurement result is input to a drawing control section 150. The drawing control section 150 controls the heating temperature of the heater 120 or the drawing speed on the basis of the received measurement result, thereby controlling the outer diameter of the optical fiber 130 to a predetermined value.

Next, the optical fiber 130 is passed through a liquid resin 171 stored in a first resin coating dice 161 to apply a first resin layer to the surface of the optical fiber 130. Subsequently, the optical fiber 130 having the first resin layer applied thereon is irradiated with UV light from a UV lamp 181, so the first resin layer hardens. In a similar way, the optical fiber 130 is passed through a liquid resin 172 stored in a second resin coating dice 162 to apply a second resin layer to the surface of the first region layer on the optical fiber 130. Subsequently, the optical fiber 130 having the second resin layer applied thereon is irradiated with UV light from a UV lamp 182, so the second resin layer hardens. In this manner, an optical fiber 200 having a resin coat 190 made of two resin layers on the surface of the optical fiber 130 is formed, as shown in FIG. 4D. The coating diameter of the optical fiber 200 at this time is, e.g., 250 μm.

Next, the optical fiber 200 is passed between a pair of guide rollers 210 for suppressing optical fiber movement, which freely rotate in the running direction of the optical fiber 200, and then sequentially guided by a swing guide roller 220, a first fixed guide roller 231 placed next to the swing guide roller 220, and a second fixed guide roller 232 placed next to the first fixed guide roller 231. The optical fiber 200 which has sequentially passed through the swing guide roller 220, first fixed guide roller 231, and second fixed guide roller 232 is wound on a drum 240.

The pair of guide rollers 210 for suppressing optical fiber movement are placed immediately above the swing guide roller 220 while being separated from the swing guide roller 220 by 100 mm. The interval between the pair of guide rollers 210 is 2 mm. For the swing guide roller 220, the roller outer diameter is 150 mm, the roller width is 30 mm, the roller surface is made of aluminum, i.e., the same material as that of the roller itself, and the rotational shaft swings around a direction parallel to the drawing tower axis (direction in which the optical fiber is drawn from the drawing furnace 110 to the swing guide roller 220) from, e.g. an angle −θ to an angle +θ at a period of 100 times/min.

The first fixed guide roller 231 is placed just beside the swing guide roller 220 while being separated from the swing guide roller 220 by 250 mm. For the first fixed guide roller 231, the roller outer diameter is 150 mm, and the roller width is 30 mm, like the swing guide roller 220, but the rotational shaft is fixed, and a narrow V groove serving as an optical fiber rolling suppression means is formed at the central portion of the roller surface. By combining the pair of guide rollers 210 for suppressing optical fiber movement, the swing guide roller 220, and the first fixed guide roller 231, which are arranged under these conditions, a predetermined twist is applied to the optical fiber 200 effectively, i.e., efficiently relative to the swing speed of the swing guide roller 220.

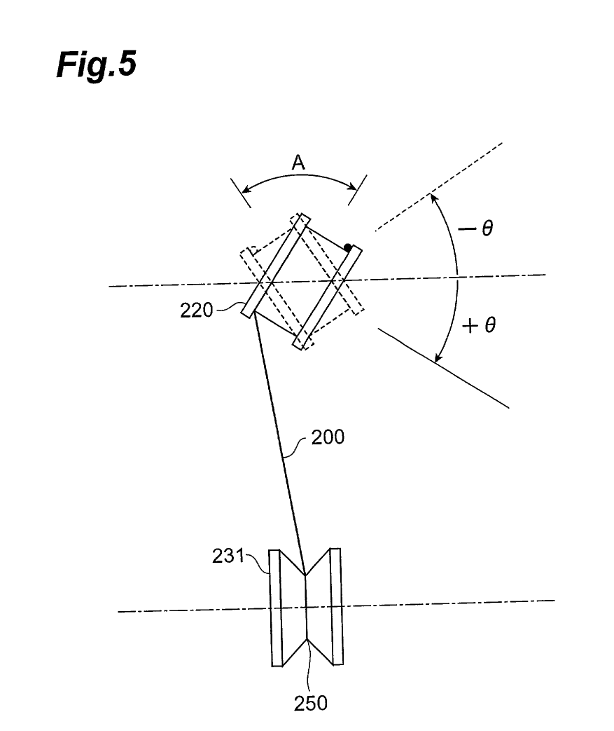

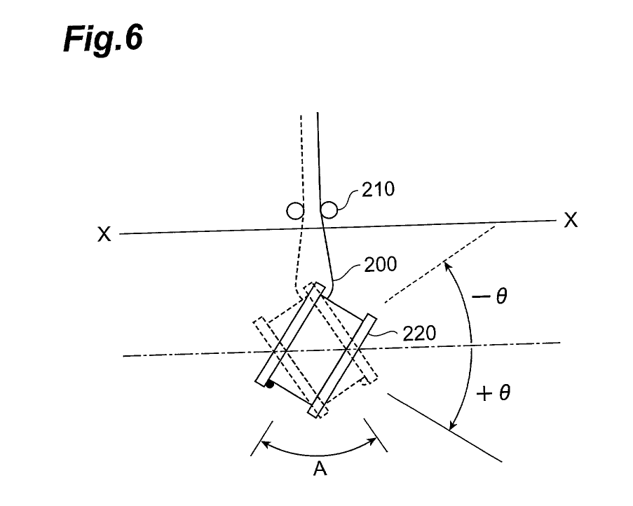

A method of applying a predetermined twist to the optical fiber 200 will be described next with reference to FIGS. 5 and 6. FIG. 5 is a plan view of the swing guide roller 220 and first fixed guide roller 231 shown in FIG. 4A. FIG. 6 shows a side view of the pair of guide rollers 210 and a plan view of the swing guide roller 220 shown in FIG. 4A.

As shown in FIG. 5, when the swing guide roller 220 tilts about a direction parallel to the drawing tower axis through the angle +θ, a horizontal force acts on the optical fiber 200 due to this tilt, so the optical fiber 200 rolls on the roller surface of the swing guide roller 220. With this rolling, a twist is applied to the optical fiber 200. Subsequently, the swing guide roller 220 tilts in the opposite direction through the angle −θ. When the symmetrical reciprocal movement of swinging the swing guide roller 220 from the angle −θ to the angle +θ is thus repeated, as indicated by a double-headed arrow A in FIG. 5, clockwise and counterclockwise twists with respect to the running direction are alternately applied to the optical fiber 200.

Since the first fixed guide roller 231 next to the swing guide roller 220 is placed just beside the swing guide roller 220 with the same roller diameter, the contact length between the optical fiber 200 and the roller surface of the swing guide roller 220 almost equals the roller circumference corresponding to an angle of circumference of 90° of the swing guide roller 220. Actually, however, the angle of circumference exceeds 90° because the first fixed guide roller 231 has a V groove. That is, the optical fiber 200 is in contact with one roller side surface to bottom surface of the swing guide roller 220 and leaves the swing guide roller 220 at its lowermost portion. This prevents a phenomenon that the optical fiber 200 rolls on the other roller side surface to impede rolling of the optical fiber 200 on one side surface and slide the optical fiber 200. Hence, since the optical fiber 200 rolls on one roller side surface of the swing guide roller 220, a twist can be applied to the optical fiber 200 efficiently relative to the swing speed of the swing guide roller 220.

A narrow V groove 250 serving as an optical fiber rolling suppression means is formed at the central portion of the roller surface of the first fixed guide roller 231. The optical fiber 200 guided by the first fixed guide roller 231 is inserted to the narrow V groove 250. This prevents a phenomenon that the optical fiber 200 rolls on the roller surface of the first fixed guide roller 231 to impede rolling on the swing guide roller 220 to apply a twist to the optical fiber 200. Hence, when rolling of the optical fiber 200 on the roller surface of the first fixed guide roller 231 is suppressed by the narrow V groove 250, a twist can be applied to the optical fiber 200 efficiently relative to the swing speed of the swing guide roller 220.

As shown in FIG. 6, when the swing guide roller 220 tilts around a direction parallel to the drawing tower axis through the angle +θ, and the optical fiber 200 rolls on the roller surface of the swing guide roller 220, the optical fiber 200 on the drawing furnace side immediately before the swing guide roller 220 also moves in the swing direction of the swing guide roller 220 as the optical fiber 200 rolls. When the optical fiber 200 moves beyond a predetermined range, the pitch of twist applied to the optical fiber 200 may be small, or the optical fiber 200 having the resin coat 190 may have a nonuniform section. However, since the pair of guide rollers 210 are placed immediately above the swing guide roller 220, when the optical fiber 200 moves beyond the predetermined range, the optical fiber 200 comes into contact with one of the pair of guide rollers 210, and further movement of the optical fiber 200 is impeded. Hence, when the pair of guide rollers 210 suppress the movement of the optical fiber 200, a reduction in pitch of the twist applied to the optical fiber 200 or nonuniform section of the optical fiber 200 having the resin coat 190 can be suppressed.

As described above, when the pair of guide rollers 210 for suppressing optical fiber movement, the swing guide roller 220, and the first fixed guide roller 231 are combined, the swing guide roller 220 rolls the optical fiber 200 on its roller surface in accordance with the swing movement to alternately apply a clockwise twist and counterclockwise twist to the optical fiber 200. In addition, since the pair of guide rollers 210 for suppressing optical fiber movement and the first fixed guide roller 231 having an optical fiber rolling suppression means assist smooth rolling of the optical fiber 200 on the roller surface of the swing guide roller 220, a twist can be applied to the optical fiber 200 efficiently relative to the swing speed of the swing guide roller 220.

The clockwise and counterclockwise twists are alternately applied to the optical fiber 200 manufactured by the above manufacturing method. For this reason, even when the sectional shapes of the core portion and cladding portion are not round and concentric, the polarization state of propagation light can be randomized.

In the above embodiment, the swing movement of the swing guide roller 220 is symmetrical reciprocal movement from the angle −θ to the angle +θ, as shown in FIG. 5. However, the present invention is not limited to this. For example, the movement may be asymmetrical reciprocal movement from an angle of 0° to the angle +θ. In this case, a twist is intermittently applied to the optical fiber 200. Alternatively, the movement may be symmetrical reciprocal movement swinging in the direction of rotational shaft of the swing guide roller 220. In this case, the clockwise and counterclockwise twists are alternately applied to the optical fiber 200, as in the above embodiment. The first fixed guide roller 231 has the narrow V groove 250 as an optical fiber rolling suppression means. However, even when a narrow U groove or narrow concave groove is formed, the same effect as described above can be obtained.

The optical fiber 200 manufactured by the above method has its glass portion twisted and can be suitably used as the Raman amplification optical fiber 32 of the Raman amplifier 1 according to this embodiment. In the manufacturing process, the average value of pitches of the twist is preferably 2 times/m or more, and more preferably, 2 to 10 times/m.

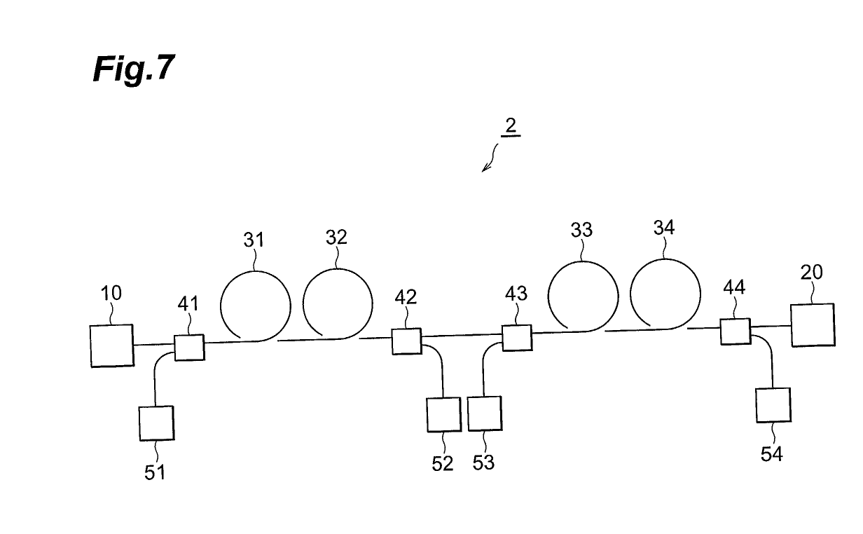

A preferred embodiment of an optical transmission system according to the present invention will be described next. FIG. 7 is a view schematically showing an optical transmission system 2 according to this embodiment. This optical transmission system 2 sequentially comprises, between an optical transmitter (or optical repeater) 10 and an optical receiver (or optical repeater) 20, an optical multiplexer 41, Raman amplification optical fiber 31, Raman amplification optical fiber 32, optical multiplexer 42, optical multiplexer 43, Raman amplification optical fiber 33, Raman amplification optical fiber 34, and optical multiplexer 44. A light source 51 for optical pumping is connected to the optical multiplexer 41. A light source 52 for optical pumping is connected to the optical multiplexer 42. A light source 53 for optical pumping is connected to the optical multiplexer 43. A light source 54 for optical pumping is connected to the optical multiplexer 44.

The Raman amplification optical fiber 31, optical multiplexer 41, and light source 51 for optical pumping form a first Raman amplifier. The Raman amplification optical fiber 32, optical multiplexer 42, and light source 52 for optical pumping form a second Raman amplifier. The Raman amplification optical fiber 33, optical multiplexer 43, and light source 53 for optical pumping form a third Raman amplifier. The Raman amplification optical fiber 34, optical multiplexer 44, and light source 54 for optical pumping form a fourth Raman amplifier. Of these Raman amplifiers, each of the second and fourth Raman amplifiers has the same arrangement as that shown in FIG. 1. For each of the first and third Raman amplifiers, though the pumping light input direction to the Raman amplification optical fiber is different from that shown in FIG. 1, it is still incorporated in the concept of the Raman amplifier according to the present invention.

Each of the Raman amplification optical fibers 31 to 34, which has a length of, e.g., several to several ten km, serves as an optical transmission line through which optical signals pass and also serves as an optical amplification medium for Raman-amplifying optical signals upon receiving pumping light. Each of the Raman amplification optical fibers 31 to 34 is a single-mode fiber in the signal wavelength band and uses silica glass as a base. To suppress waveform degradation in optical signals due to accumulated wavelength dispersion, each of the Raman amplification optical fibers 31 to 34 is preferably formed from a dispersion-shifted optical fiber having a zero dispersion wavelength near but not exactly the same as the optical signal wavelength (1.55 μm).

Each of the light sources 51 to 54 for optical pumping outputs pumping light and preferably comprises, e.g., a semiconductor laser source. The optical multiplexer 41 inputs pumping light output from the light source 51 for optical pumping to the Raman amplification optical fiber 31 and passes optical signals sent from the optical transmitter 10 to the Raman amplification optical fiber 31. The optical multiplexer 42 inputs pumping light output from the light source 52 for optical pumping to the Raman amplification optical fiber 32 and passes the optical signals Raman-amplified by the Raman amplification optical fiber 32 downstream. The optical multiplexer 43 inputs pumping light output from the light source 53 for optical pumping to the Raman amplification optical fiber 33 and passes the optical signals arriving from the optical multiplexer 42 to the Raman amplification optical fiber 33. The optical multiplexer 44 inputs pumping light output from the light source 54 for optical pumping to the Raman amplification optical fiber 34 and passes the optical signal Raman-amplified by the Raman amplification optical fiber 34 to the optical receiver 20. Note that when the wavelength of optical signals is about 1.55 μm, the wavelength of pumping light for Raman amplification is about 1.45 μm, i.e., shorter than the wavelength of the optical signals by about 0.1 μm.

In this optical transmission system 2, pumping light output from the light source 51 for optical pumping is supplied to the Raman amplification optical fiber 31 through the optical multiplexer 41. Pumping light output from the light source 52 for optical pumping is supplied to the Raman amplification optical fiber 32 through the optical multiplexer 42. Pumping light output from the light source 53 for optical pumping is supplied to the Raman amplification optical fiber 33 through the optical multiplexer 43. Pumping light output from the light source 54 for optical pumping is supplied to the Raman amplification optical fiber 34 through the optical multiplexer 44. optical signals sent from the optical transmitter 10 sequentially propagate through the Raman amplification optical fibers 31 to 34. The optical signals suffer transmission loss while propagating through the Raman amplification optical fibers 31 to 34 and are also Raman-amplified by the Raman amplification optical fibers 31 to 34. The Raman-amplified optical signals reach the optical receiver 20 and are received by the optical receiver 20.

In this optical transmission system 2, the effective loss in the optical transmission line between the optical transmitter 10 and the optical receiver 20 can be reduced. In addition, a nonlinear optical phenomenon that is caused when the optical signals have too large power at various portions of the optical transmission line can be suppressed.

Each of the Raman amplification optical fibers 31 to 34 has a polarization coupling means for inducing coupling between the polarization components of propagation light. This polarization coupling means is formed from, e.g., a twist applied to the glass portion of each Raman amplification optical fiber. To randomize the polarization state by coupling between polarization components of propagation light, the average value of pitches of the twist is preferably 2 times/m or more, and more preferably, 2 to 10 times/m. By this polarization coupling means, the polarization states of the optical signals and pumping light are randomized in the longitudinal direction of each of the Raman amplification optical fibers 31 to 34, and the Raman amplification gain (i.e., the power of the optical signals arriving at the optical receiver 20) is averaged and stabilized over time. Since the optical transmission system 2 employs the arrangement of the above-described Raman amplifier 1, the number of optical components is small, and the system is inexpensive.

The present invention is not limited to the above embodiments, and various changes and modifications can be made. For example, in the optical transmission system 2 shown in FIG. 7, a Raman amplification optical fiber may be used at part of the optical transmission line in the repeater section between the optical transmitter 10 and the optical receiver 20.

As has been described above in detail, according to the Raman amplifier of the present invention, pumping light is supplied from an pumping light supply means to a Raman amplification optical fiber. Optical signals input to the Raman amplification optical fiber suffer transmission loss while propagating through the Raman amplification optical fiber and are also Raman-amplified by the Raman amplification optical fiber and output from the Raman amplification optical fiber. In the Raman amplification optical fiber, by the polarization coupling means for inducing coupling between polarization components of propagation light, the polarization states of the optical signals and pumping light are randomized in the longitudinal direction of the Raman amplification optical fiber. Hence, the Raman amplification gain of the Raman amplifier is averaged and stabilized over time. In addition, the number of optical components is small, and the system is inexpensive.

When the polarization coupling means of the Raman amplification optical fiber is a twist applied to the glass portion, coupling is induced between the polarization components of propagation light by this twist, so the polarization states of the optical signals and pumping light are randomized in the longitudinal direction of the Raman amplification optical fiber. In addition, when the average value of pitches of the twist is 2 times/m or more, it is suitable to induce sufficient coupling between the polarization components of propagation light.

According to the optical transmission system of the present invention, optical signals that propagate through the optical transmission line in the repeater section suffer transmission loss while propagating through the Raman amplification optical fiber and are also Raman-amplified by the Raman amplification optical fiber to be output. Hence, the effective loss in the optical transmission line can be reduced, and a nonlinear optical phenomenon that is caused when the optical signals have too large power at various portions of the optical transmission line can be suppressed. In the Raman amplification optical fiber, by the polarization coupling means for inducing coupling between polarization components of propagation light, the polarization states of the optical signals and pumping light are randomized in the longitudinal direction of the Raman amplification optical fiber. Hence, the Raman amplification gain (i.e., the power of the optical signals arriving at the receiving end) is averaged and stabilized over time. In addition, the number of optical components is small, and the system is inexpensive.

From the foregoing explanations of the invention, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A Raman amplifier comprising:
a Raman amplification optical fiber through which optical signals pass and which Raman-amplifies the optical signals upon receiving pumping light, said Raman amplification optical fiber having polarization coupling means for inducing coupling between polarization components of propagation light; and
pumping light supply means for supplying the pumping light to said Raman amplification optical fiber.

2. An amplifier according to claim 1, wherein said polarization coupling means comprises a twist applied to a glass portion of said Raman amplification optical fiber.

3. An amplifier according to claim 2, wherein an average value of pitches of the twist is not less than 2 times/m.

4. An optical transmission system having said Raman amplifier of claim 1 in a repeater section,
wherein said Raman amplification optical fiber of said Raman amplifier constitutes at least a part of an optical transmission line of the repeater section.
